(19) United States
(12) Patent Application Publication
(10) Pub. No.: US 2026/0001289 A1
(43) Pub. Date: Jan. 1, 2026

(54) METHOD WITH INCREASED RELIABILITY FOR MANUFACTURING A COMPOSITE TUBULAR STRUCTURE COMBINING PULTRUSION AND FILAMENT WINDING

(71) Applicant: EPSILON COMPOSITE, GAILLAN-EN-MEDOC (FR)

(72) Inventors: José PORTOLES, QUEYRAC (FR); Yann CHAUMET, Gaillan en Médoc (FR)

(21) Appl. No.: 19/257,219

(22) Filed: Jul. 1, 2025

(30) Foreign Application Priority Data
Jul. 1, 2024 (FR) 2407159

(51) Int. Cl. B29C 70/52; B29C 70/86; B29K 63/00; B29K 105/10; B29K 307/04

(52) U.S. Cl. CPC B29C 70/52; B29C 70/86; B29K 2063/00; B29K 2105/101; B29K 2307/04

(57) ABSTRACT

The present disclosure relates to a method for producing a tubular composite structure with a longitudinal axis, the method successively including a step of forming a manufacturing blank by stacking material to construct at least one tubular sandwich with a longitudinal axis, said tubular sandwich(S) comprising two filament winding layers based on raw resin and carbon fibers, and a series of pultruded spacers based on carbon fibers and at least partially cured resin, the pultruded spacers being arranged radially to the longitudinal axis between the two filament winding layers, and a step of curing the manufacturing blank to obtain the composite tubular structure.

### CROSS-REFERENCE TO RELATED APPLICATIONS

The present application claims priority to French Application No. 2407159 filed with the Intellectual Property Office of France on Jul. 1, 2024, which is incorporated herein by reference in its entirety for all purposes.

### TECHNICAL FIELD OF THE INVENTION

The present invention falls within the general field of composite materials. More specifically, it relates to a method for manufacturing a roll of composite material formed by at least one sandwich in the form of an annular series of pultruded stiffeners, or spacers, interposed between two composite layers produced by filament winding.

### TECHNICAL BACKGROUND

Rotating rollers, conventionally made of metal such as steel or aluminum, are widely used in industry for a variety of applications, such as paper printing and transformation, technical film manufacture, and non-woven textile processing.

In practice, higher production rates mean that the width and/or speed of these rollers must be increased.

However, this trend comes up against the {mass-inertia-stiffness} limitation of metal rollers: the targeted increase in width and/or speed of rotation cannot be achieved without these rollers being subjected to unexpected deformation under load, parasitic vibratory behavior or axis stability defects, leading to a loss in production quality.

The study of solutions to overcome these limiting factors for improving production has highlighted the value of using composite materials to replace metal in the manufacture of rotating rollers. Carbon fiber composites are particularly well-suited to the task, as they are stiffer and lighter than steel.

On this basis, it was initially proposed to manufacture the rollers entirely by filament winding, which involves winding continuous, resin-impregnated carbon fibers around a rotating mandrel.

This technique makes it possible to manufacture homogeneous rotating rollers that perform significantly better than those obtained with metalworking. For example, in the flexographic printing sector, roller speeds have been increased from 150 to 250 m/min for a width of 900 to 1200 mm.

Continuous research into performance has led the inventors of the present invention to propose a multi-material shaping method known as “winding-pultrusion”. As the name suggests, this winding-pultrusion method consists in combining filament winding with pultrusion. The pultrusion technique is based on impregnating and bonding carbon fibers from bundles using a single polymer matrix.

The “winding-pultrusion” method, known from FR2871215B1, consists in producing rolls in the form of at least one multi-material sandwich comprising two tubular layers produced by filament winding and a series of pultruded spacers interposed between these two winding layers.

Document GB2602033 describes a method for manufacturing a rotor body for a rotary sail. The method described in GB2602033 comprises winding first fibers around a mandrel to form a tubular skin defining a rotor tube having a longitudinal axis; making a plurality of strips from second fibers; and attaching these strips to the surface of the first skin, so that some of the second fibers extend along the axis of the rotor body.

In practice, the addition of pultruded spacers between two layers of filament winding makes it possible to manufacture rolls with significantly higher stiffness than rolls obtained by filament winding alone. Such a multi-material assembly also inherently limits vibratory phenomena, since the natural frequencies of the pultruded spacers do not overlap with those of the two winding layers.

This winding-pultrusion method offers manufacturers rolls with larger widths and/or which can be rotated at even higher speeds than those produced using filament winding alone, while maintaining optimum production quality.

However, quality control tests carried out during production have shown that some of the rollers manufactured show a significant reduction in mechanical properties compared with the theoretical potential expected, which in a critical case could lead to scrapping due to non-compliance with the imposed specifications. As a result, the winding-pultrusion method can be improved.

The invention is thus part of an approach to perfecting the winding-pultrusion method by understanding the observed phenomenon and, on this basis, defining the implementation parameters that will lead to more reliable production.

### DESCRIPTION OF THE INVENTION

To this end, the object of the invention is a method for producing a tubular composite structure with a longitudinal axis, such as a composite tube of revolution about the longitudinal axis, the method successively comprising:
a step of forming a manufacturing blank by stacking material to construct at least one tubular sandwich with a longitudinal axis, said tubular sandwich comprising two filament winding layers based on raw resin and carbon fibers, and a series of pultruded spacers based on carbon fibers and at least partially cured resin, the pultruded spacers being arranged radially to the longitudinal axis between the two filament winding layers; and
a step of curing the manufacturing blank to obtain the composite tubular structure;
wherein the pultruded spacers and the filament winding layers of the manufacturing blank are parameterized so as to ensure that the composite structure, obtained after the curing step, has a longitudinal modulus, a specific longitudinal modulus and a transverse modulus satisfying the double condition:
the specific longitudinal modulus is between 52,300 KNm/Kg and 258,400 KNm/Kg; and
a ratio between longitudinal modulus and transverse modulus of between 5 and 65.

According to other features of the invention:
said at least one sandwich of the manufacturing blank is formed during the construction step so as to respect a carbon fiber volume distribution of more than 35% in the pultruded spacers and less than 65% in the filament winding layers, relative to the total volume of carbon fibers in the manufacturing blank;
the winding layers are formed during the manufacturing blank construction step at a fiber winding angle greater than 30° with respect to the longitudinal axis;
the spacers used to form said at least one sandwich during the manufacturing blank construction step have a fiber volume fraction greater than 65%;
the spacers have a fiber volume fraction of between 65% and 75%;
the spacers and the winding layers are parameterized so as to have a lapshear and radial tensile strength at their interface which is greater than 15 MPa at the end of the manufacturing blank curing step;
the manufacturing blank construction step is carried out by:
providing spacers which are shaped based on anhydride-hardened epoxy resin; and
forming filament winding layers based on amine-hardened epoxy;
the resin of the spacers used during the manufacturing blank construction step has a cure rate of between 70% and 90%;
the resin of the spacers used during the manufacturing blank construction step has a cure rate of between 75% and 85%;
the spacers and winding layers are parameterized so as to have a resistance to cracking at their interface of at least 100 J/m², advantageously greater than 150 J/m², at the end of the manufacturing blank curing step.

### BRIEF DESCRIPTION OF THE DRAWINGS

Further features and advantages of the invention will become apparent from the following detailed description, for the understanding of which reference is made to the appended drawings wherein:

FIG. 1 is a schematic partial and perspective view of a tubular composite sandwich manufactured according to the winding-pultrusion method, formed by an annular series of pultruded spacers encapsulated between two filament winding layers;

FIG. 2 is a cross-sectional view of a roll manufactured according to the winding-pultrusion method, showing a crack pattern at the interface between the spacers and the filament winding layers;

FIG. 3 is a cross-sectional view of a roll produced according to the winding-pultrusion method, showing a radial and circumferential crack pattern in the spacers;

FIG. 4 is a cross-sectional view of a roll manufactured according to the winding-pultrusion method, showing another circumferential crack pattern along the filament winding layers;

FIGS. 5a-5d each show a section of a table listing a set of batches of test samples manufactured and subjected to analysis to assess the influence of different parameters for implementing the winding-pultrusion method on the cracking phenomenon highlighted in FIGS. 2, 3 and 4;

FIGS. 6a-6d show the cracking rates obtained for all the batches listed in FIGS. 5a to 5d.

### DETAILED DESCRIPTION OF THE INVENTION

The invention forms part of a study aimed at assessing opportunities for improving the winding-pultrusion manufacturing method suitable for the manufacture of composite rolls, known from document FR2871215B1.

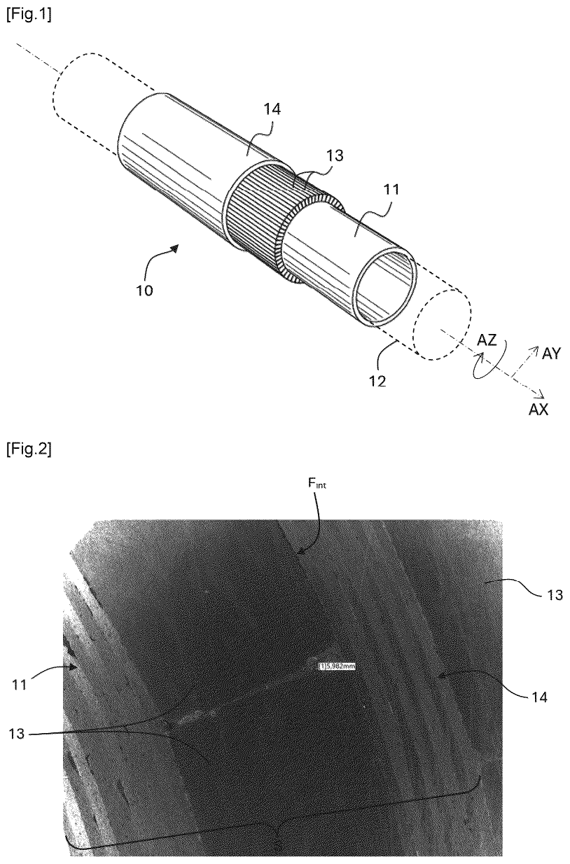

With reference to FIG. 1, the winding-pultrusion method described in the improvement according to the invention is based on the construction of a manufacturing blank referenced 10. This manufacturing blank is in the form of at least one tubular sandwich S resulting from the successive sub-steps of:
a) forming a first layer 11 by filament winding of continuous, resin-impregnated carbon fibers around a rotating mandrel 12 of longitudinal axis AX, this first layer 11 internally delimiting the sandwich S along a radial direction noted AY which is orthogonal to axis AX;
b) attaching spacers 13 made of a carbon-fiber-based composite material, produced upstream by pultrusion, to the first layer 11, advantageously spaced evenly around the periphery in a circumferential direction AZ; then
c) by filament winding of resin-impregnated continuous carbon fibers, building a second layer 14 radially around the spacers 13 to externally delimit the sandwich S.

Once the manufacturing blank 10 has been obtained in this way, it is advisable, in the context of the winding-pultrusion method adopted by the inventors of the present improvement, to proceed with a curing step to achieve rapid and effective polymerization of the resin, in particular the resin making up the first and second layers 11, 14.

Unlike pultrusion resin that has already been cured, that is to say resin that has been at least partially polymerized, or at least mostly cured, by being drawn through a heating die to give the spacers 13 their shape and very high rigidity, the resin in the filament winding layers 11, 14 of the manufacturing blank 10 is in raw, that is to say uncured, form.

Even if in practice certain filament winding resins are able to polymerize without the addition of heat, that is to say at room temperature, curing the manufacturing blank is preferred in particular to:
meet the requirements of industrial-scale production, given that room-temperature polymerization requires the mandrel 12 on which the manufacturing blank 10 is built to be immobilized for a significant period of time, of the order of a few days to several weeks;
avoid the risk of imperfect polymerization of filament winding layers 11, 14, particularly at their core and at their interface with spacers 13,
avoid the risk of resin embrittlement through chemical alteration, due to its tendency to spontaneously absorb moisture in its raw state. Such embrittlement leads directly to a reduction in the final mechanical properties of the resulting roll.

Thus, in accordance with the implementation of the method covered by the improvement according to the invention, a roll is formed by means of the successive steps of constructing the manufacturing blank 10 and curing said manufacturing blank 10.

Note that this manufacturing blank 10 is not strictly limited to a single sandwich S for the purposes of the invention. In practice, a manufacturing blank 10 can also be formed from several sandwiches S stacked one on top of the other, in the form of a mille-feuilles, or laminated, before being cured. Specifically, the aforementioned construction steps b) and c) can be repeated cyclically to form a series of radially successive sandwiches S. In this case, the sandwiches have a filament-wound layer in pairs: the second layer 14 on the outside of a sandwich S corresponds to the first layer 13 of the sandwich S built above it. The examples in FIGS. 2 and 3 show this particular arrangement.

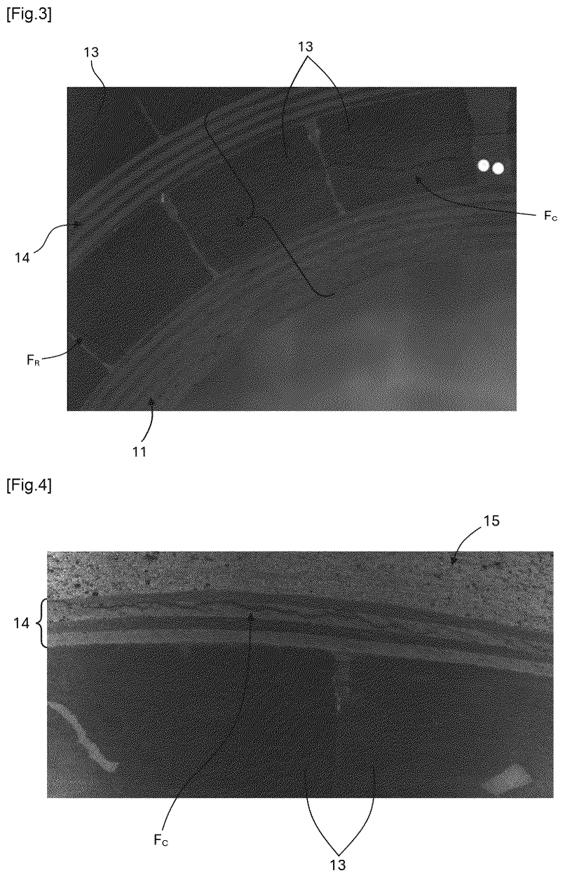

Without going beyond the scope of the present invention, a soft coating, that is to say a sacrificial coating suitable for machining, can also be deposited around the manufacturing blank 10, that is to say around the layer 14 which externally delimits the manufacturing blank 10. This soft coating, visible and noted 15 in the example of FIG. 4, is a non-structural consumable that is intended to be machined downstream of the curing process to rectify the roll's circular cross-sectional shape as required. In particular, it is recommended when specifications call for severe form tolerance. By way of example, such a coating 15 can be formed from glass fiber fleece, glass fabric, non-woven fibers, elastomer or pure or filled resin.

Numerous quality control tests carried out by the inventors have shown that a significant proportion of the rolls formed in this way are subject to cracking, which is responsible for a reduction in mechanical properties. In detail, it has been observed in a non-systemic way that 3% to 10% of the rolls tested show cracks, in particular during short curing periods (less than 24 h) at temperatures above 60° C., or even above 80° C., leading to a polymerization rate of over 90% of the rolls.

With reference to FIGS. 2, 3 and 4, visual cross-sectional assessment of the rolls tested, that is to say along a cross-sectional plane normal to the corresponding axis AX, made it possible to distinguish three crack patterns:
cracking, noted as Fint in FIG. 2, at the pultruded-wound interface, that is to say delamination between a filament winding layer 11, 14 and at least one of the radially facing spacers 13;
radial F_{R} and/or circumferential F_{C} cracking extending through one or more spacers 13, as shown in FIG. 3; or
a circumferential crack F_{C} extending along a filament winding layer 11, 14, as shown in FIG. 4.

The observation of such cracks led the inventors to question the origin of this phenomenon. It has been envisaged that these cracks are due to the particularity of curing a cured material and a raw material, which is inherent to the winding-pultrusion method: the simultaneous co-curing of the already-cured spacers 13 and the raw winding layers 11, 14 would generate internal stresses in the manufacturing blanks 10.

To validate this approach and establish a phenomenological law for characterizing cracking behavior on this basis, a comparative analysis was carried out on roll samples. This analysis is based on a variation in several controllable parameters of the winding-pultrusion method, with a presumed impact on the generation of internal stresses during curing and/or resistance to the appearance/propagation of cracks, in order to quantify their influence.

“Controllable” parameters are distinguished from environmental parameters that are difficult to control in industrial production, these parameters for example being:
workshop temperature, which can vary between 10° C. and 40° C.;
tooling temperature, which can vary between 10° C. and 50° C.;
workshop humidity between 20% and 90%;
the manufacturing time, which can vary between 30 minutes and 600 minutes, measured between the start of production and the curing of the manufacturing blank 10;
the epoxy index of the filament winding resins;
the rate of polymerization initiation of the filament winding resin prior to introduction into the curing process.

It was thus observed in the course of this study that the occurrence of cracking can be limited to a rate of less than 4% when the spacers 13 and the winding layers 11, 14 are conditioned so as to form rolls exhibiting both:
a longitudinal rigidity along the axis AX, otherwise known as the specific flexural modulus E1s, of between 52,300 KNm/Kg and 258,400 KNm/Kg; and
a ratio between flexural modulus E1 (expressed in MPa) and torsional modulus (expressed in MPa), also referred to as transverse modulus G, which is between 5 and 65.

In particular, it has been demonstrated that the rate of cracking can be further limited when the above-mentioned double condition is satisfied and:
the percentage by volume of carbon fibers in the manufacturing blank 10 consists of more than 35% in the spacers 13 and, correspondingly, less than 65% in the filament winding layers 11, 14; and/or
the filament winding layers 11, 14 are formed at a winding angle greater than or equal to 30° relative to axis AX.

Thus, it has been observed that conditioning spacers 13 so that they have a fiber volume fraction greater than 65%, ideally between 65 and 75% with less than 1% porosity, makes it possible to aim for a cracking rate of less than 2.2% in combination with the above-mentioned criteria.

Conditioning the spacers 13 and filament winding layers 11, 14 to ensure sufficient adhesion between them to guarantee a lapshear and radial tensile strength in excess of 15 MPa has in particular been described as further reducing the cracking rate to below 2%

Finally, it has been demonstrated that compliance with the preceding and following criteria contributes overall to limiting the cracking rate to virtually zero:
constructing the manufacturing blank 10 with partially cured spacers 13, that is to say spacers whose resin is not fully cured, of the order of 70 and 90% cure rate, and ideally between 75% and 85%;
conditioning the spacers 13 and the filament winding layers 11, 14 so as to guarantee a cracking resistance G1c greater than 100 J/m², and advantageously greater than 150 J/m².

The following section presents the test results on the basis of which the above-mentioned criteria for using the method according to the invention to limit the occurrence of cracking were formulated.

### Test and Manufacturing Die

As part of this study, a number of roller samples were manufactured under standard workshop conditions, and instrumented with various sensors such as force gauges. After validation of the samples' conformity with the sensors, they were divided into two hundred separate batches, each comprising between two and four samples of virtually identical parameters.

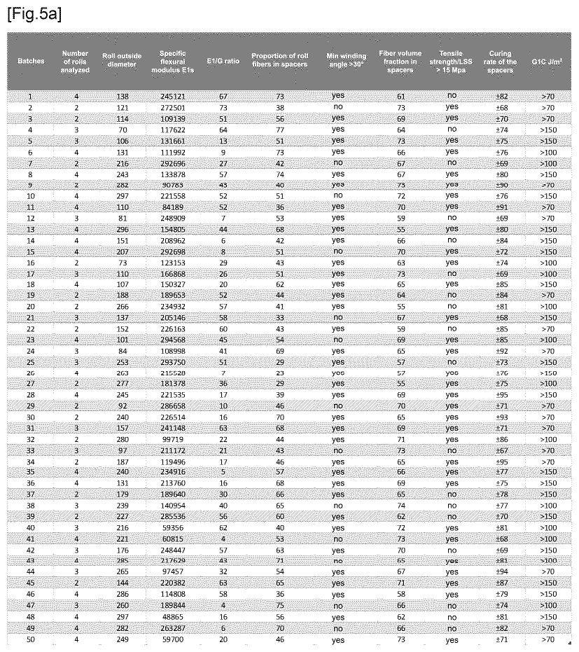

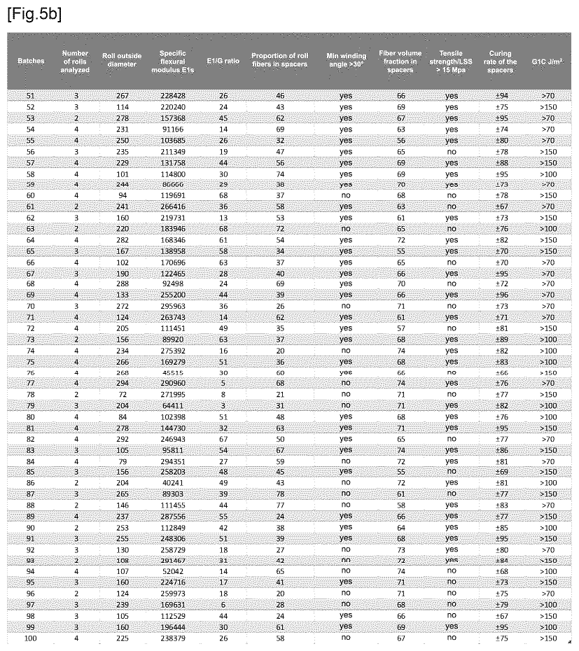

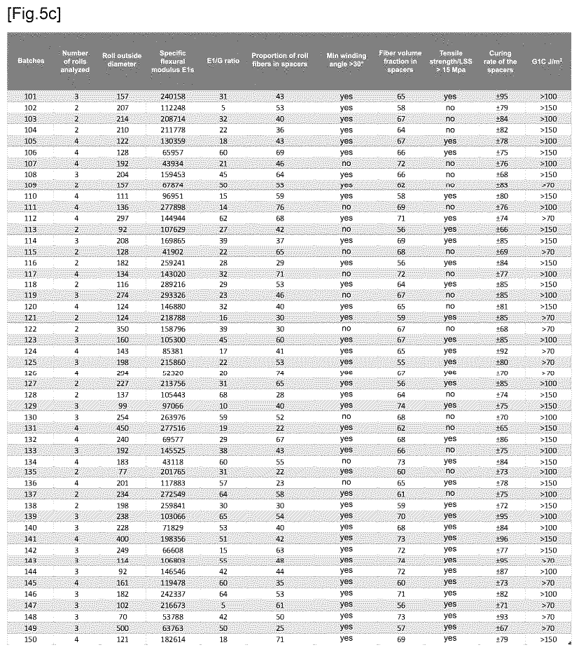

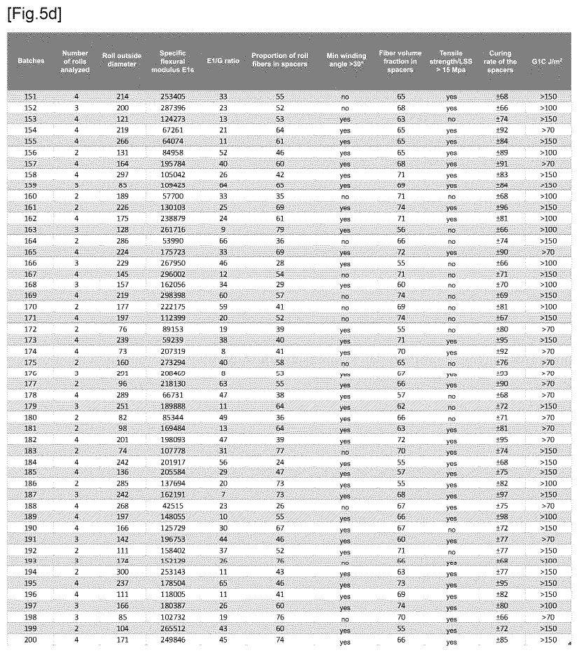

As listed column by column in the tables shown in FIGS. 5a to 5d, the batches of rolls 1 to 200 manufactured can be distinguished from one another by the combination of the following parameters, also known as study regressors:
outside diameter, measured in mm;
specific modulus E1s, that is to say specific longitudinal stiffness according to AX, expressed in KNm/Kg;
E1/G ratio (modulus in MPa), that is to say the ratio between longitudinal and torsional stiffness;
the proportion of carbon fibers contained in the spacers 13 out of the total volume of carbon fibers in the manufacturing blank 10;
the angle induced during formation of the filament winding layers 11, 14 relative to the axis AX, and more specifically whether or not an angle value greater than 30 is valid;
the volume fraction occupied by the carbon fibers in the spacers 13 making up the manufacturing blank 10, corresponding to the inverse of the volume fraction associated with the pultruded resin;
lapshear and radial tensile strength (noted as Traction/LSS), expressed in MPa, and more specifically whether or not a measured strength value greater than 15 MPa is valid;
the cure rate of the spacers 13 used to construct the sandwich(es) S making up the manufacturing blanks 10, upstream of the co-curing step together with the filament winding layers 10, 14; and
the cracking resistance G1c, measured in J/m², between the spacers 13 and the filament winding layers 10, 14;

### Assessment of Cracking Rate and Analysis of Results

For the purposes of this study, the cracking rate for each batch of samples corresponds to the occurrence of cracking determined under the same operating conditions as described below:
a series of cross-sections, that is to say normal to axis AX, are made on each sample, then assessed by Digital Microscopy or Tomography;
on each of the 10 mm×10 mm images generated by digital microscopy or tomography, any cracks are identified; then
the cracking rate for each batch is calculated as the ratio of the number of images recorded with visible crack(s) to the number of images without visible cracks.

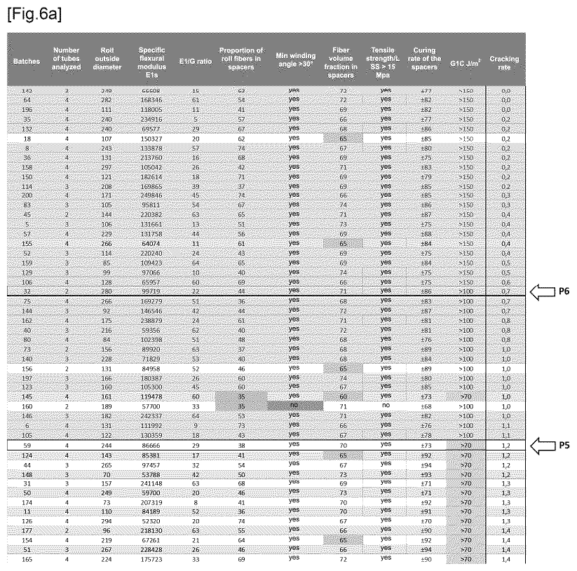

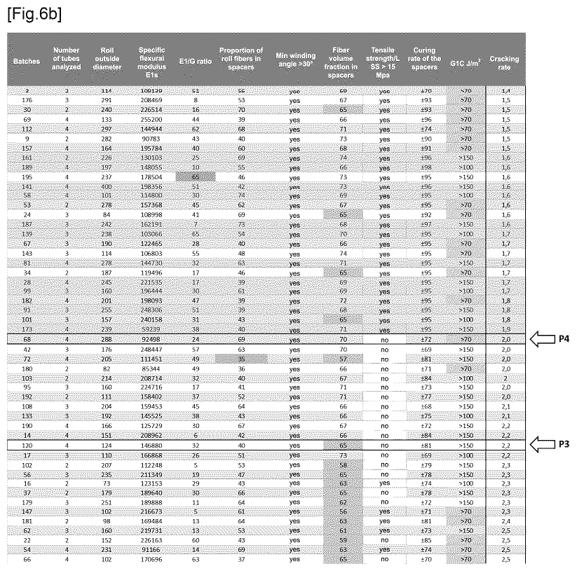

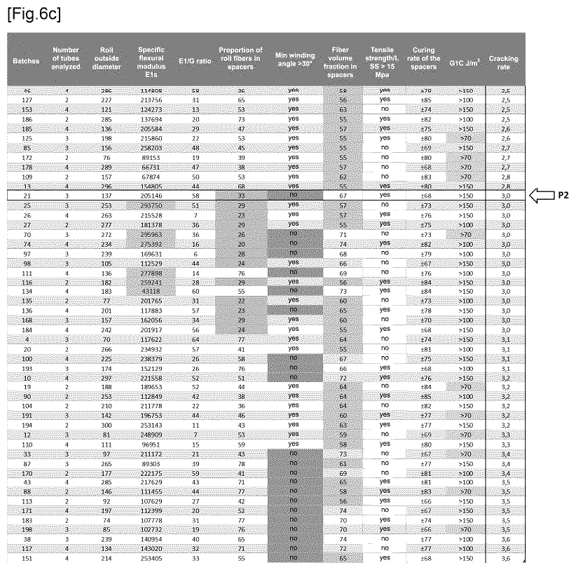

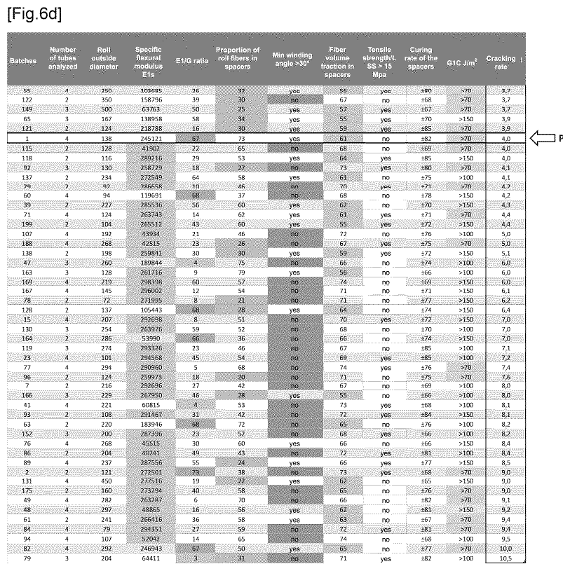

The tables in FIGS. 6a to 6d correspond to the tables in FIGS. 5a to 5d, which have been both enhanced with the cracking rate values determined and arranged by ordering the batches in ascending order of cracking rate. This layout provides a bottom-up view of the gains to be made by complying with the various above-mentioned criteria, with a view to limiting or even eliminating the occurrence of cracking.

### First Criterion Established

With reference to FIG. 6d, a first plateau, noted P1, can be directly identified below which the samples of the batches:
exhibit a cracking rate in excess of 4%, up to 10.5% for the batch identified as the most severely affected by cracking in this study; and
fail to meet the double condition of having a specific flexural modulus E1s of between 52,300 KNm/Kg and 258,400 KNm/Kg, and an E1/G ratio of between 5 and 65.

With regard to the plateau P1 identified, it is surprising to note that conditioning the winding-pultrusion method to produce rolls with an E1/G ratio of between 5 and 65 for a specific flexural modulus E1s of between 52,300 KNm/Kg and 258,400 KNm/Kg limits the cracking rate to a value below 4%.

In the context of the invention, it is therefore recommended that this criterion be met first, in the form of a limiting condition for implementing the method.

On analysis, this capping of the cracking rate at a value below 4% is based on the interaction between the winding layers 11, 14 and the spacers 13 under the effect of differential expansion.

In practice, as the manufacturing blank 10 rises in temperature during the curing step, the spacers 13 and the winding layers 11, 14 tend to expand. Conversely, post-curing cooling to room temperature causes the spacers 13 and winding layers 11, 14 to shrink.

By nature, the pultruded spacers 13, because they are already cured, tend to expand significantly more than the winding layers 11, 14. Such differential expansion generates internal stresses, particularly during post-curing cooling, as the winding layers 11, 14 are set by resin polymerization. As is well understood, the shrinking of the spacers 13, which seek to return to their original state, generates a significant radial force on the winding layers 11, 14, which have conversely stiffened in the expanded state.

Parameterizing the construction of the manufacturing blank 10 in accordance with this first criterion means in practice guaranteeing a transverse modulus G large enough for the filament winding layers to oppose the expansion of the spacers 13. By preventing the expansion of the spacers 13 during the rise in curing temperature, shrinkage is limited on return to room temperature, and the internal stresses generated in the product roll are therefore limited.

### Second and Third Additional Criteria

FIG. 6c shows a plateau P2, marking a distinction between batches in terms of the percentage of carbon fiber by volume and the winding angle of the filament winding fibers.

In detail, it appears with respect to this plateau P2 that it is permissible to limit the cracking rate to a value below 3% provided that one of the following additional criteria is met:
the proportion by volume of carbon fibers in the manufacturing blank 10 corresponds to less than 65% in the filament winding layers 11, 14 and, correspondingly, more than 35% in the spacers; and
the filament winding layers 11, 14 are formed at a winding angle greater than or equal to 30° relative to axis AX.

In practice, these two criteria contribute both individually and in synergy to increasing the transverse modulus G, and thus to achieving the E1/G ratio values in compliance with the first established criterion, as well as further limiting the cracking rate with respect to compliance with this first criterion alone.

In fact, the greater the angle of the winding fibers, that is to say the greater their distance from the longitudinal orientation along AX, up to 90°, the greater their ability to absorb radial forces and thus resist expansion of the spacers 13. Thus, increasing the proportion of fiber by volume in the filament windings of the manufacturing blank 10 up to 65% directly increases the transverse modulus G.

### Fourth Additional Criterion

With reference to FIG. 6b, a plateau noted P3 is identified as marking the limit of influence of the carbon fiber volume fraction of the spacers 13 produced within the scope of this study.

In detail, this plateau P3 highlights that the rolls manufactured with spacers 13 formed with a fiber content of over 65%, in other words with a resin content of less than 35%, show cracking rates of less than 2.2% in conjunction with compliance with the other aforementioned criteria. This study further shows that a fiber content of between 65 and 75% in the spacers 13, advantageously with less than 1% porosity, ensures the best results.

Although shaping the spacers 13 with a carbon fiber content higher than 65% is contraindicated in the literature for fear of running out of resin to ensure good overall cohesion, this study has overcome this prejudice to move toward greater crack limitation.

Since resin has a significantly higher coefficient of expansion than carbon, this study shows that increasing the fiber content to over 65% reduces the intrinsic expansion of the spacers 13 during curing sufficiently to ensure a reduction in the radial forces exerted on the winding layers 11, 14. Such a reduction in the radial forces applied to the winding layers 11, 14 tends in particular to limit the circumferential cracks F_{C}, as identified in FIG. 4, appearing specifically therein.

### Fifth Additional Criterion

A plateau P4 is also shown in FIG. 6b. This plateau P4 shows that if the adhesion between the spacers 13 and the winding layers 11, 14 is sufficient to guarantee a lapshear and tensile strength in excess of 15 MPa, it is possible to limit the cracking rate to less than 2%, while complying with the other above-mentioned criteria.

Compliance with such a lapshear and tensile strength threshold of 15 MPa in practice counteracts the appearance of the interface cracks FINT observed in FIG. 2.

It should be noted that adhesion is based on several parameters, including the chemical natures and compatibilities of the resins used to form the spacers 13 and filament winding layers 11, 14.

In order to achieve this lapshear and tensile strength value, it is advantageously suggested in the context of the invention to:
shape the spacers 13 based on epoxy resin with anhydride hardener; and
construct the carbon fiber filament winding layers 11, 14 on an epoxy base with amine hardener.

This comparative study shows that this resin combination is particularly powerful in meeting lapshear and tensile strengths in excess of 15 MPa between the spacers 13 and the winding layers 11, 14.

It should be stressed, however, that the invention is not strictly limited to these two types of resin. In fact, any combination of resins that satisfies the identified adhesion criterion, that is to say guaranteed lapshear and tensile strengths in excess of 15 MPa, can be used without departing from the scope of the invention.

It was also revealed during this study that the more or less advanced state of polymerization of the resin of the pultruded spacers 13 used during the construction step of the manufacturing blank 10, that is to say before it is cured, has an impact on the effective lapshear and tensile strength.

As already mentioned, at the stage of shaping the manufacturing blank 10, the resin used to form the spacers 13 has already been heated to polymerize and ensure a certain rigidity. However, this study shows that it is preferable to opt for incomplete polymerization of the resin in the spacers 13 used to construct the manufacturing blank 10. This feature gives the residual resin in the spacers 13, that is to say the portion of resin that has not yet completed polymerization, the opportunity to mix locally with the resin making up the filament winding layers 10, 14 during their co-cure, that is to say during the overall cure of the downstream manufacturing blank 10.

Such a blend of resins then provides mechanical anchoring at the interface between the spacers 13 and the winding layers 11 after the manufacturing blank 10 has been cured, helping to guarantee the aforementioned criterion of lapshear and tensile strength in excess of 15 MPa.

In view of the test values obtained, it is advantageously recommended for the purposes of the invention that the cure rate of the resin of the spacers 13 be of the order of 70% to 90% at the stage of construction of the manufacturing blank 10. In particular, the best results were obtained with a resin cure rate for the spacers 13 of between 75% and 85%. The resin cure rate of the spacers 13 was evaluated in this study by means of residual enthalpy measurements directly after pultrusion, that is to say before their use to build the sandwiches S of the manufacturing blanks 10.

It should be noted that lowering the cure rate to a value below 70% is contraindicated in the context of the invention. If polymerization is too weak, there is a risk that the pultruded spacers 13 will suffer various types of damage, such as fouling, loss of geometry, cracking or plasticization followed by hydrolysis due to moisture absorption during storage.

### Sixth Additional Criterion

Finally, FIG. 6a shows two plateaus, P5 and P6, which show the benefits of conditioning the spacers 13 and the filament winding layers 11, 14 so as to guarantee a cracking resistance G1c at their interface of a value greater than 100 J/m² and 150 J/m², respectively, after curing the manufacturing blank.

In detail, it appears that setting the parameters of the winding-pultrusion method so as to achieve a cracking resistance value of G1c 100 J/m² enables the cracking rate to be capped at 1.2%. Exceeding 150 J/m² in G1c cracking resistance further reduces the cracking rate to below 0.7%.

This analysis shows that a cracking resistance G1c at least greater than 100 J/m², and advantageously greater than 150 J/m², at the interface between the spacers 13 and the winding layers 11, 14, makes it possible to effectively oppose the propagation of any incipient interface cracks Fint and confine them. The onset of such interface cracks Fint is generally observed at small geometric singularities in the spacers 13, which form pockets of overstress during curing of the manufacturing blank 10.

### Method According to the Invention and Applications

Based on the comparative analysis carried out, it has thus been possible to highlight the various criteria for implementing the winding-pultrusion method in accordance with the invention, with a view to limiting the rate of cracking in the rolls produced.

Even if compliance with all the above criteria is the most optimal solution for limiting the occurrence of cracks, even to the point of achieving a “zero crack” situation, it is clear that the invention is not limited to this particular feature. In practice, all or some of these criteria can be met from the least stringent to the most stringent, that is to say from the first criterion to the sixth. The choice of whether to meet all or just some of these criteria in series depends in concrete terms on the permissible cracking rate for a given application.

Thus, it should be noted that the method according to the invention is not limited to the manufacture of rolls as in the example, that is to say rotationally symmetrical parts with a constant longitudinal section. The winding-pultrusion method described here can be used to produce a variety of tubular structures, in other words, a variety of hollow structures.

1. A method for producing a tubular composite structure with a longitudinal axis, such as a composite tube of revolution about the longitudinal axis, the method successively comprising:
a step of forming a manufacturing blank by stacking material to construct at least one tubular sandwich with a longitudinal axis, said tubular sandwich comprising two filament winding layers based on raw resin and carbon fibers, and a series of pultruded spacers based on carbon fibers and at least partially cured resin, the pultruded spacers being arranged radially to the longitudinal axis between the two filament winding layers; and
a step of curing the manufacturing blank to obtain the composite tubular structure;
said at least one sandwich of the manufacturing blank being formed during the construction step so as to respect a carbon fiber volume distribution of more than 35% in the pultruded spacers and less than 65% in the filament winding layers, relative to a total volume of carbon fibers in the manufacturing blank; and
the winding layers being formed during the manufacturing blank construction step at a fiber winding angle greater than 30° with respect to the longitudinal axis.

2. The method according to claim 1, wherein the spacers used to form said at least one sandwich during the manufacturing blank construction step have a fiber volume fraction greater than 65%.

3. The method according to claim 2, wherein the spacers have a fiber volume fraction of between 65% and 75%.

4. The method according to claim 2, wherein the spacers and the winding layers are parameterized so as to have a lapshear and radial tensile strength at their interface which is greater than 15 MPa at the end of the manufacturing blank curing step.

5. The method according to claim 4, wherein the manufacturing blank construction step is carried out by:
providing spacers which are shaped based on anhydride-hardened epoxy resin; and
forming filament winding layers based on amine-hardened epoxy.

6. The method according to claim 4, wherein the resin of the spacers used during the manufacturing blank construction step has a cure rate of between 70% and 90%.

7. The method according to claim 6, wherein the resin of the spacers used during the manufacturing blank construction step has a cure rate of between 75% and 85%.

8. The method according to claim 4, wherein the spacers and the winding layers are parameterized so as to have a resistance to cracking at their interface of at least 100 J/m², advantageously greater than 150 J/m², at the end of the manufacturing blank curing step.
